(19) United States
(12) Patent Application Publication
(10) Pub. No.: US 2007/0214673 A1
(43) Pub. Date: Sep. 20, 2007

(54) Tool-measuring apparatus for measuring a tool in a tool holder, and a tool holder

(75) Inventor: Christian Pfau, Bietigheim-Bissingen (DE)

Correspondence Address: POSZ LAW GROUP, PLC, 12040 SOUTH LAKES DRIVE, SUITE 101, RESTON, VA, 20191, US

(73) Assignee: E. Zoller GmbH & Co. KG, Einstell- und Mess-gerate, Freiberg/Neckar (DE)

(21) Appl. No.: 11/717,023

(22) Filed: Mar. 13, 2007

(30) Foreign Application Priority Data
Mar. 15, 2006 (DE) 10 2006 011 814.6

(51) Int. Cl. B23Q 17/22

(52) U.S. Cl. 33/628

(57) ABSTRACT

A tool-measuring device that measures a tool in a tool holder and that includes a measuring device and a processing device. The processing device controls the measuring device. The tool-measuring device measures a measuring point of the tool holder at a location relative to an apparatus point. In order to counter an error during the measurement of the tool, which error may be caused by a thermal change in size of the tool or of the tool holder or by an operator error, the processing device controls a measurement of a measuring point of the tool holder at another location and a position of a holder point of the tool holder relative to the apparatus point by the two measurements.

### CROSS REFERENCE TO RELATED APPLICATION

This application is related to, claims priority from, and incorporates by reference German Patent Application No. DE 10 2006 011 814.6, filed on Mar. 15, 2006.

### TECHNICAL FIELD

The invention relates to a tool-measuring apparatus for measuring a tool in a tool holder. The invention also relates to a tool holder.

### BACKGROUND

For the exact machining of a workpiece, in particular with a multi-spindle machine tool, it is advisable to position the cutting tools very precisely in tool holders. In order to be able to position the tool exactly in the tool holder, the tool is first of all measured in a tool holder of a tool-measuring apparatus. To this end, the position of the tool holder relative to a measuring-apparatus zero point of the tool-measuring apparatus is measured, and then the tool is measured. In order to be able to determine the position of the tool holder relative to the measuring-apparatus zero point, the tool holder as a rule has a measuring element prepared for a position measurement and having a measuring point which can be scanned by a suitable measuring means, such that its position can be determined.

The desired position and the actual position of an element of a tool, for example of a tool cutting edge, are normally specified in coordinates, the coordinate zero point of which lies in a rotation axis of the tool and slightly outside the tool holder. The position of this theoretical tool zero point, which is not physically visible, is certainly fixed relative to the tool holder, but it cannot be measured itself for calibrating the tool-measuring apparatus, since no measuring element can be attached there. The measuring element is therefore arranged at another location of the tool holder and its coordinates are measured with respect to the fixed tool zero point by a calibrating unit and are written, for example, on the tool holder.

During a subsequent measurement of the tool in the tool holder, the position of the visible measuring point on the tool holder relative to an apparatus zero point of the measured tool-measuring apparatus is then determined to begin with. The position of the theoretical tool zero point of the tool in the tool holder is then determined by means of the position of the measuring point and of the position data, written on the tool holder, of the measuring point. And then the position of an element of the tool, for example a cutting edge, is measured and specified in the normal coordinates with respect to the tool zero point.

In this method, however, inaccuracies may occur during the measurement of the tool. It is therefore an object of the invention to specify a tool-measuring apparatus and a tool holder, so that an accurate measurement of the tool relative to the tool zero point can be carried out.

### SUMMARY

In view of the above, a tool-measuring apparatus for measuring a tool in a tool holder is provided and comprises a measuring means and a processing means for controlling the measuring means for measuring a measuring point of the tool holder at a location relative to an apparatus point.

The processing means can be provided for controlling a measurement of a measuring point of the tool holder at another location and for determining a position of a holder point of the tool holder relative to the apparatus point by means of the two measurements.

### BRIEF DESCRIPTION OF THE DRAWINGS

Further advantages follow from the description below of the drawing. Exemplary embodiments of the invention are shown in the drawing. The drawing, the description and the claims contain numerous features in combination. The person skilled in the art will also expediently consider the features individually and form appropriate further combinations.

FIG. 1 shows a tool-measuring apparatus for measuring a tool in a tool holder,

FIG. 2 shows the tool holder with a tool in a spindle of the tool-setting apparatus,

FIG. 3 shows the tool holder in a position rotated by 180°,

FIG. 4 shows another tool holder in a schematic plan view, and

FIG. 5 shows a tool holder inserted into the spindle in a tilted manner.

### DETAILED DESCRIPTION

An exemplary embodiment is based on the idea that the actual position of the measuring point relative to the tool zero point possibly does not coincide with the coordinates of the measuring point which have been determined by the calibrating unit and have been written, for example, on the tool holder. This inaccuracy is transferred to the measurement of the tool element. A deviation of an instantaneous actual position of the measuring point from a desired position which is characterized by coordinates stored on the tool holder may occur if the tool holder, due to thermal contraction, has a size or shape different from that during the original measurement of the measuring point in the calibrating unit. Such a thermal contraction normally affects the tool holder symmetrically, that is to say approximately identically on both sides of its rotation axis. By a measurement of one or more measuring points at a plurality of locations, for example opposite one another with respect to the rotation axis, in a triangle, in a rectangle or in other positions relative to one another, a position of the rotation axis can be detected independently of a linear contraction of the measuring point. The tool zero point normally lying in the rotation axis can be determined with a satisfactory accuracy and as a result the tool can be accurately measured and positioned, for example, in the tool holder.

The tool zero point is certainly a point on or in the tool, normally within the tool chuck of the tool, but it can also be considered as a holder zero point, belonging to the tool holder, or generally as a holder point due to the exact positioning of the tool in the tool holder. In general, a holder point is in particular a point characteristic of the tool holder and/or of its position in any manner.

A tool-measuring apparatus is in particular an apparatus for measuring a tool. It may additionally perform other functions; e.g. it may be provided for a position setting of the tool, such as, for example, a length setting of a cutting tool in the tool holder. The apparatus point is in particular a coordinate zero point of the measuring means; it may be arranged in a fixed position in the tool-measuring apparatus, for example by a reference point of one or more glass scales. The processing means may comprise a processor and serve as a control means for controlling the measuring means and as an evaluating means, e.g. for determining the position of the holder point. The measuring point can be established by a measuring element specifically prepared for a measurement and is preferably fixed relative to the tool holder. The measuring point is in particular spaced-apart from the holder point, which is expediently the tool zero point for specifying tool coordinates. The position of the holder point can be determined from measured values of the measurement. The tool holder may be an auxiliary holder with a chuck arranged therein, or may only be an auxiliary holder. The tool may be a cutting tool with or without a tool chuck fastened thereto. The holder point may come to lie outside the tool holder, for example within the tool chuck. The two locations are expediently predetermined in their position relative to one another. They are expediently arranged opposite one another relative to an axis of symmetry of the tool holder, in particular the rotation axis of the tool holder.

The position of the measuring point in particular relative to the tool-measuring apparatus is determined by the measurement of the measuring element. For this purpose, the tool-measuring apparatus expediently comprises a means of movement for moving the measuring point or the measuring element establishing it between the two measurements from the first location to the second location. The two measurements can be carried out using a single measuring element. In addition, a circular movement of the measuring element about the rotation axis of the tool holder can ensure that the measuring point at both locations is at exactly the same distance from the rotation axis and a point of the rotation axis can be determined very accurately as a result. The movement may take place manually or may advantageously be controlled by the processing means.

The tool holder can be designed in an especially simple manner if the processing means is prepared for measuring one and the same measuring element first of all at the first location and then at the second location.

In a further configuration, two or more measuring elements of the tool holder which are prepared for a measurement can be measured for their position at the two locations or at even more locations. The holder point in this case can be simply determined if the measuring points or the measuring elements establishing them are arranged opposite one another relative to an axis of symmetry of the tool holder, in particular relative to the rotation axis of the tool holder.

Especially detailed information on the position of the tool holder and for example its spatial orientation can be obtained if two or more measuring points are first of all measured for their position at a respective first location, then at least one of the measuring points is moved to a respective second location and is then measured at this second location. In this case there is a plurality of first positions which are arranged spatially at different locations.

The processing means is advantageously prepared for using the position of the holder point as a reference point for a tool measurement. As a result, computing cost can be kept down and the number of error sources can be kept small. The use may be an output of a position of the tool with respect to the position of the holder point, in which case the output can be affected, for example, on a display screen or as a signal to be processed further.

The position of the holder point can be determined in a simple manner if the processing means is provided for determining a center position between the locations. The locations are in this case expediently arranged opposite one another with respect to the rotation axis of the tool holder or of the tool. The center position can be determined with respect to a single coordinate direction, other coordinate directions being disregarded. The center position is in this case expediently the position of the holder point, which thus lies centrally between the locations.

A further embodiment provides for the processing means to be provided for determining the position of the holder point from a center position between the locations and a predetermined transverse distance transversely to a connecting line between the locations. The measuring point or the two locations can be arranged largely independently of the position of the holder point on the tool holder. The length of the transverse distance can be stored in the processing means and/or written on the tool holder.

The transverse distance may also be subjected to a thermal contraction, as a result of which a measurement of the tool in the direction of the transverse distance may be affected by an undesirable inaccuracy. This inaccuracy can be countered if the processing means is provided for determining a correction of the position of the holder point from a distance between the locations. The correction may in this case be a length correction of a predetermined transverse distance between a direct connecting line between the locations and the holder point.

Furthermore, it is proposed that the processing means be provided for determining an error distance between the holder point and an instantaneous rotation axis from measurements of the measuring points. This enables a situation to be detected in which the tool holder is inserted inaccurately into, for example, a spindle of the tool-measuring apparatus and the axis of symmetry of the tool holder, which can coincide with its correct rotation axis, does not coincide with the rotation axis of the spindle. The error can be detected and the tool holder, for example, can be inserted again. The instantaneous rotation axis may be a spindle axis of a spindle of the tool-measuring apparatus.

The processing means is advantageously provided for determining an error angle between an axis of symmetry of the tool holder and an instantaneous rotation axis from measurements of the measuring points. Incorrect insertion of the tool holder can be detected and an incorrect measurement can be countered.

A tool holder may also be provided for clamping a tool in place, having a measuring element designed for a measurement and an axis of symmetry. It is proposed that the tool holder have a further measuring element designed for a measurement, the two measuring elements being opposite one another with respect to the axis of symmetry. A holder point lying in the axis of symmetry can be determined in a simple manner by a measurement of the two measuring elements, and an error of the linear contraction can be countered. The measuring elements expediently establish a respective measuring point. The measuring elements—in contrast to their surroundings—are advantageously designed specifically for a measurement.

The two measuring elements each expediently comprise a measuring means for measuring transversely to the axis of symmetry. In this way, a distance between measuring points established by the measuring elements or from the measuring points to the axis of symmetry can be detected in a simple manner. The measurement serves in particular for the position measurement of the measuring elements or the measuring points. If at least one of the measuring elements has a measuring means for measuring along and transversely to the axis of symmetry, a separate measuring element for measuring a distance along the axis of symmetry can be dispensed with.

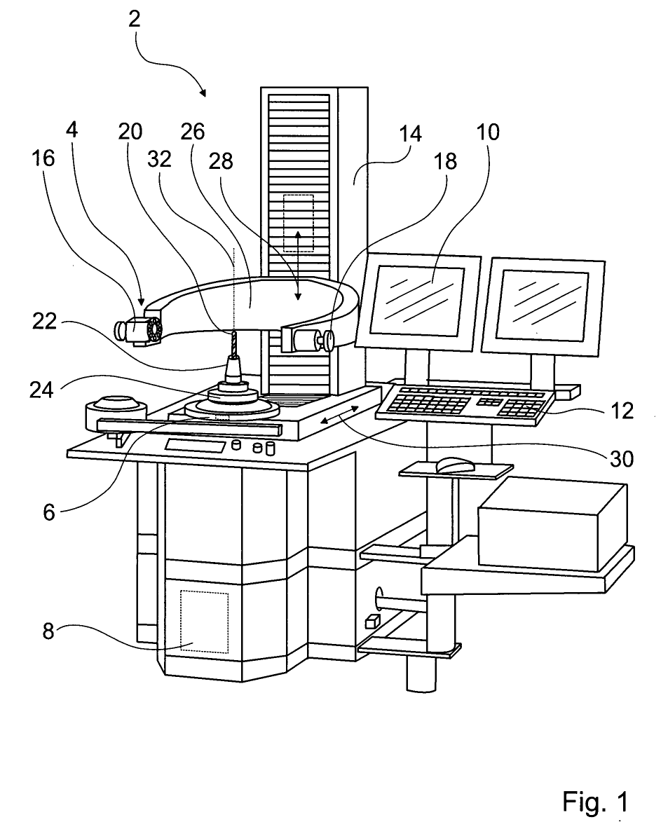

FIG. 1 shows a tool-measuring apparatus 2 having an optical measuring means 4, a spindle 6, a processing means 8, which is connected to two display screens 10 and an input means 12 designed as a keyboard, and a means 14 of movement for moving the measuring means 4. The processing means 8 is designed as an apparatus for data processing with a processor and a memory. The measuring means 4 comprises a camera 16 and a lighting unit 18 for the transillumination of a tool 20. Part of the tool 20 is a tool chuck 22, which is carried in a tool holder 24, which in turn is accommodated by the spindle 6 in a rotatably mounted manner. The measuring means 4 can be traversed both vertically and horizontally by the means 14 of movement, as shown by the arrows 28, 30. A fork-shaped retaining means 26 can spaciously enclose the tool 20, and large tools and the tool holder 24 can also be measured, both in front of and behind a tool axis 32, for their shape or position relative to a, for example static, apparatus point of the tool-measuring apparatus.

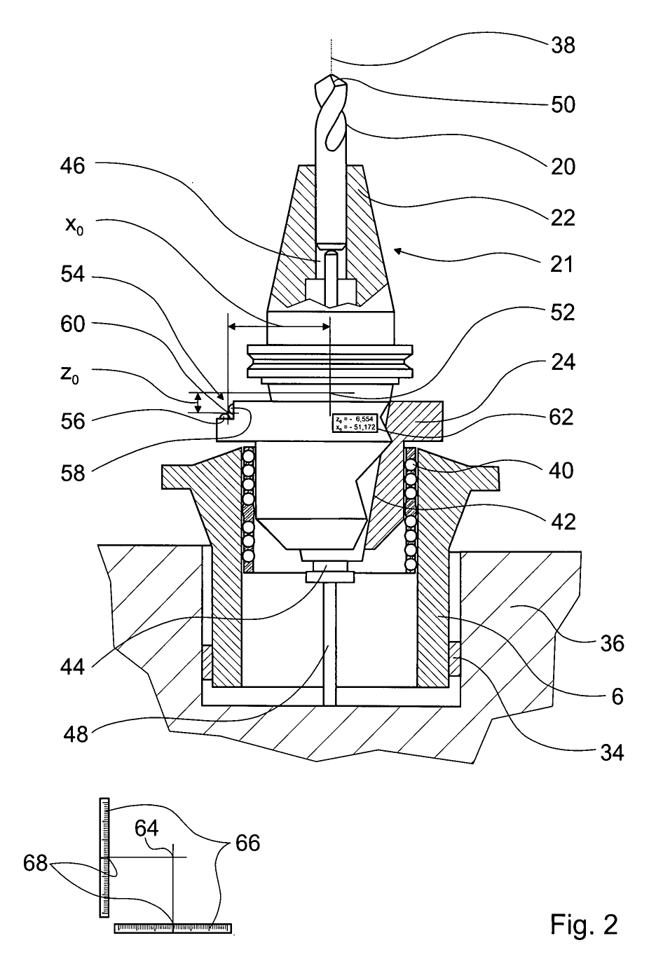

FIG. 2 shows the spindle 6, the tool holder 24 and the tool 20 with a cutting tool 21 and its tool chuck 22 in an enlarged and partly sectioned illustration. By means of bearings 34 (only shown schematically), the spindle 6 is mounted in a base 36 of the tool-measuring apparatus 2 in such a way as to be rotatable about a spindle axis 38, which in FIG. 2 coincides with the tool axis 32. The tool axis 32 is at the same time an axis of symmetry of the tool holder 24. By means of a ball bush 40, the tool holder 24, designed as an auxiliary holder, is in turn rotatably mounted in the spindle 6. Accommodated in a tapered receptacle 42 of the tool holder 24 is a bottom part, designed with an adapted taper, of the tool chuck 22, which has a clamping shank 44 for clamping in place in the spindle 6 by means of a clamping mechanism (not shown). The cutting tool 21, designed as a drill bit, is clamped in place in a receptacle 46 of the tool chuck 22, for example by thermal shrink fitting. A positioning means 48 in the form of a stop rod is passed through the spindle 6, the tool holder 24 and the tool chuck 22, reaches right into the receptacle 46 and strikes the cutting tool 21. When the cutting tool 21 is still not clamped in place in the receptacle 46, the positioning means 48 thus holds the cutting tool 21 in a defined position.

Geometric position data of the cutting tool 21, for example the position of a cutting edge 50, are normally specified with respect to a tool zero point, which is designated below as holder point 52. Its position is established and standardized relative to the tapered bottom part of the tool chuck 22. With regard to its vertical position, the holder point 52 or tool zero point lies within the tool 20 and slightly above the tool holder 24. Due to the receptacle 42 adapted to the tapered bottom part of the tool chuck 22, the tool zero point is also a fixed point with respect to the tool holder 24 and is therefore a holder point 52. However, other points of the tool holder 24 may also be designated as holder points.

The processing means 8 is prepared for outputting position data of the tool 20 with respect to this holder point 52 or tool zero point. If the cutting edge 50 is to be measured and its position specified relative to the tool zero point, the position of the tool zero point relative to a defined apparatus point must be known to the processing means 8. The tool zero point should therefore be capable of being determined by a measurement. For this determining of the tool zero point, the tool holder 24 comprises a measuring element 54 having two balls 56, 58 which are fastened in metallic depressions of the tool holder 24 and which serve as measuring means and define a measuring point 60 of the tool holder 24. The measuring element 54 is fixed relative to the rest of the tool holder 24, such that the measuring point 60 is at a fixed distance from the tool zero point. This distance can be measured by a calibrating unit and can be logged on a data carrier, for example on a plate 62, on the tool holder 24. The distance in this case is composed of a distance z₀ parallel to the tool axis 32 and a distance x₀ transversely to the tool axis 32.

To measure the holder point 52, the tool holder 24 is rotated either manually or by a corresponding drive of the spindle 6 until the direction of the distance x₀ is transverse to a direction of view of the camera 16, that is to say transverse to the connecting axis between the camera 16 and the lighting unit 18. The measuring element 54 now points toward the camera 16, as shown in FIG. 2. The top edge of the ball 56 is now measured, to be precise for its position in the z direction relative to an apparatus point 64 which is implemented as a system zero point and is defined by two reference marks 68 by means of two glass scales 66 in the interior of the tool-measuring apparatus 2. The x value and the z value of the position of the measuring point 60 relative to the apparatus point 64 are thus determined by optically scanning the glass scales 66 and the ball 58 in the z direction and x direction. By addition of the known distances x₀, z₀ to the x value and z value, respectively, of the measuring point 60 relative to the apparatus zero point 64, the coordinates of the holder point 52 with respect to the apparatus point 64 can now be determined. A position of the cutting edge 50 can accordingly be specified with respect to the holder point 52.

During this measurement, however, fluctuations of the actual distances x₀, z₀ of the holder point 52 relative to measuring point 60, which fluctuations are caused by thermal expansions or contractions of the tool chuck 22 and/or of the tool holder 24, are still not taken into account. Said fluctuations are for the time being not known to the processing means 8 and therefore lead to inaccuracies when specifying a position of the cutting edge 50 relative to the holder point 52. These inaccuracies can be considerably reduced if the position of the measuring point 60, after a measurement at a first location relative to the apparatus point 64, is measured at a second location whose position relative to the apparatus point 64 differs from the position of the first location.

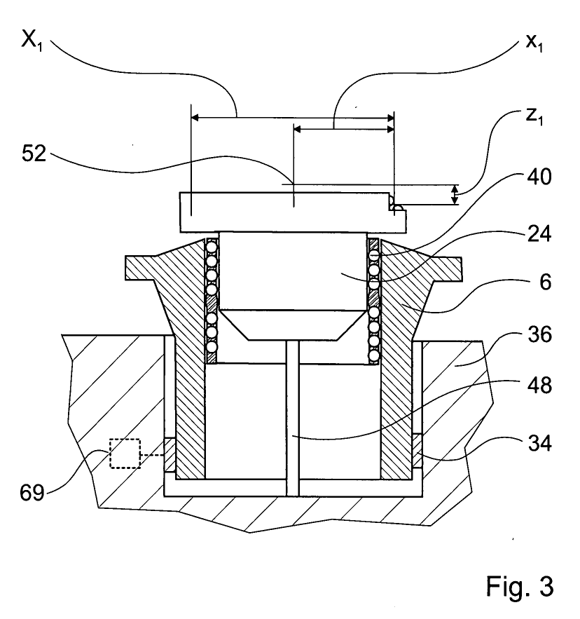

FIG. 3 shows the tool holder 24 rotated by 180° about the spindle axis 38 relative to the base 36 of the tool-measuring apparatus 2 and therefore shows the measuring point 60 at a location different from that in FIG. 2. The rotation can be carried out manually by a user, who takes hold of the spindle 6 on the outside and rotates it in the bearing 34. In this case, the bearing 34 would be a means of movement. To simplify the manipulation, a drive 69 (only shown schematically) can rotate the spindle 6 in the bearing 34 and thus serve as a means of movement. By renewed measurement of the balls 56, 58 for their position relative to the apparatus point 64, a distance X₁ between the two locations of the measuring point 60 for the first and the second measurement can be determined. By the distance X₁ being halved, the processing means 8 determines a distance x₁ between the location of the measuring point 60 and a center position between the two locations. Since a thermal change in size of the tool holder 24 takes place uniformly as a rule, this center position lies in the tool axis 32 and therefore in the axis in which the holder point 52 lies. In this way, the x coordinate of the holder point 52 can be determined very accurately. The distances x₀ and x₁ may differ from one another by a small amount, namely by precisely the thermal change in size. Since the holder point 52 is arranged symmetrically within the tool holder 24, it can be assumed that the distance x₁ defines the x coordinate of the holder point 52 relative to the apparatus point 64 more accurately than the distance x₀ measured beforehand by the calibrating unit. Therefore, during a measurement of the measuring point 60 at two different locations, a calibration measurement of the distance x₀ can be dispensed with, and the two measurements of the measuring point 60 at the two locations can be used for determining the x coordinate of the holder point 52.

However, it may be the case that a difference between the distances x₀ and x₁ is systematically reflected in a difference between the distance z₀ determined by the calibrating unit and a true distance z₁ between the holder point 52 and the top edge of the ball 56 in the z direction. Such systematic influencing of the differences can be determined, for example, empirically and can be stored in the processing means 8. With determination of the difference between the distances x₀ and x₁, the distance can therefore be used for correcting the distance z₀ to the distance z₁ in order to determine the position of the holder point 52 relative to the apparatus point 64 even more accurately. In this exemplary embodiment, the distance x₀ would likewise have to be determined by the calibrating unit despite the measurement of the measuring point 60 at two locations.

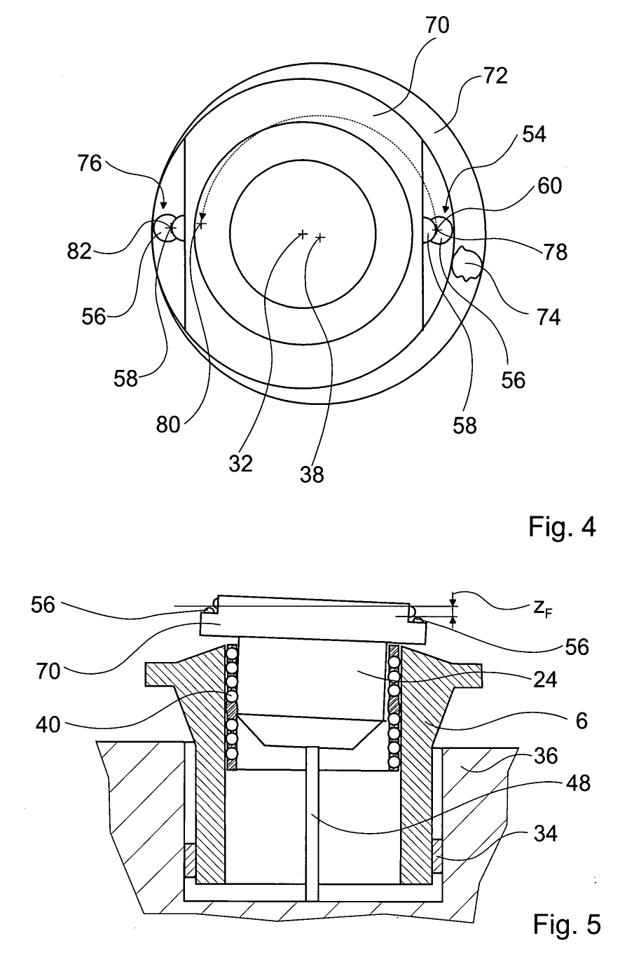

FIG. 4 shows a further exemplary embodiment having a tool holder 70 which is shown in plan view and is arranged in an opening 72 of the spindle 6. A contaminant 74, shown excessively large for the sake of clarity, is jammed between the tool holder 70 and an inner surface of the spindle 6, as a result of which the position of the tool axis 32 differs from the position of the spindle axis 38. Instead of the contaminant 74, a defect in the ball bush 40 is also conceivable. Components that essentially remain unchanged are in principle provided with the same designations. Furthermore, with regard to features and functions that remain unchanged, reference may be made to the description of the exemplary embodiment in FIGS. 1 to 3. The description below is essentially restricted to the differences from the exemplary embodiment in FIGS. 1 to 3. The tool holder 70 comprises two measuring elements 54, 76 with in each case a ball 56 for measuring the z coordinate and a ball 58 for measuring the x coordinate. The two measuring elements 54, 76 are arranged opposite one another with respect to the tool axis 32. If the measuring point 60 at a first location 78 is now measured and the spindle 6 and with it the tool holder 70 is rotated by 180°, the measuring point 60 comes to lie at a second location 80. A calculation of the measuring point as described with regard to FIG. 3 would result in the holder point 52 lying in the spindle axis 38, which is not the case on account of the different positions of the tool axis 32 and the spindle axis 38.

To detect such an error, the tool holder 70 comprises two measuring elements 54, 76 whose distances x₀ from the holder point 52 are known to the processing means 8. The position of the holder point 52 with respect to the apparatus point 64 can be determined from these known distances x₀—in combination with the distances z₀ of the measuring points 60, 82. The processing means 8 detects an error distance of the holder point 52 determined by the distances x₀ and of the point at the location 80 which is determined by the center point calculation and lies in an instantaneous rotation axis or spindle axis 38. The processing means 8 can draw attention to an error, so that an operator can insert the tool holder 70 into the spindle 6 again and start a new measuring process.

In FIG. 5 the tool holder 70 is shown inserted into the spindle 6 in a tilted manner. From the measurement of the two balls 56, the processing means 8 can detect that the two balls 56 are arranged with an error distance z_{F} at a different height with respect to the spindle 6 or the apparatus point 64. Since the distances z₀ of the two balls with respect to the tool zero point 52 are known to the processing means 8, their relative distance in the z direction—caused by production inaccuracies for example—is also known to the processing means 8. If the measured relative distance z_{F} differs from the known relative distance in the z direction by more than a predetermined value, the processing means 8 detects an error, which is equal to an error angle between the tool axis 32 or an axis of symmetry of the tool holder 24 and an instantaneous rotation axis or the spindle axis 38. The processing means 8 can deliver a warning, which causes an operator to insert the tool holder 70 into the spindle 6 again. In this way, an error during the measurement of the tool 20 can be effectively countered.

The invention is described herein in detail with particular reference to presently preferred exemplary embodiments. However, it will be understood that variations and modifications can be effected within the scope and spirit of the invention.

What I claim is:

1. A tool-measuring apparatus for measuring a tool in a tool holder, comprising a measuring means and a processing means for controlling the measuring means for measuring a measuring point of the tool holder at a location relative to an apparatus point, wherein the processing means is provided for controlling a measurement of a measuring point of the tool holder at another location and for determining a position of a holder point of the tool holder relative to the apparatus point by means of the two measurements.

2. The tool-measuring apparatus as claimed in claim 1, which comprises a means of movement for moving the measuring point between the two measurements from the first location to the second location.

3. The tool-measuring apparatus as claimed in claim 1, wherein the two measuring points are arranged opposite one another relative to an axis of symmetry of the tool holder.

4. The tool-measuring apparatus as claimed in claim 2, wherein the two measuring points are arranged opposite one another relative to an axis of symmetry of the tool holder.

5. The tool-measuring apparatus as claimed in claim 1, wherein the processing means is prepared for using the position of the holder point as a reference point for a tool measurement.

6. The tool-measuring apparatus as claimed in claim 2, wherein the processing means is prepared for using the position of the holder point as a reference point for a tool measurement.

7. The tool-measuring apparatus as claimed in claim 1, wherein the processing means is provided for determining a center position between the locations.

8. The tool-measuring apparatus as claimed in claim 2, wherein the processing means is provided for determining a center position between the locations.

9. The tool-measuring apparatus as claimed in claim 1, wherein the processing means is provided for determining the position of the holder point from a center position between the locations and a predetermined transverse distance transversely to a connecting line between the locations.

10. The tool-measuring apparatus as claimed in claim 2, wherein the processing means is provided for determining the position of the holder point from a center position between the locations and a predetermined transverse distance transversely to a connecting line between the locations.

11. The tool-measuring apparatus as claimed in claim 1, wherein the processing means is provided for determining a correction of the position of the holder point from a distance between the locations.

12. The tool-measuring apparatus as claimed in claim 2, wherein the processing means is provided for determining a correction of the position of the holder point from a distance between the locations.

13. The tool-measuring apparatus as claimed in claim 1, wherein the processing means is provided for determining an error distance between the holder point and an instantaneous rotation axis from measurements of the measuring points.

14. The tool-measuring apparatus as claimed in claim 2, wherein the processing means is provided for determining an error distance between the holder point and an instantaneous rotation axis from measurements of the measuring points.

15. The tool-measuring apparatus as claimed in claim 1, wherein the processing means is provided for determining an error angle between an axis of symmetry of the tool holder and an instantaneous rotation axis from measurements of the measuring points.

16. The tool-measuring apparatus as claimed in claim 1, wherein the processing means is provided for determining an error angle between an axis of symmetry of the tool holder and an instantaneous rotation axis from measurements of the measuring points.

17. A tool holder for clamping a tool in place, having a measuring element designed for a measurement and an axis of symmetry, which comprises a further measuring element designed for a measurement, the two measuring elements being opposite one another with respect to the axis of symmetry.

18. The tool holder as claimed in claim 17, wherein both measuring elements each have a measuring means for measuring transversely to the axis of symmetry.

19. The tool holder as claimed in claim 17, wherein at least one of the measuring elements has a measuring means for measuring along and transversely to the axis of symmetry.

20. The tool holder as claimed in claim 18, wherein at least one of the measuring elements has a measuring means for measuring along and transversely to the axis of symmetry.
